(19) United States
(12) Patent Application Publication
(10) Pub. No.: US 2014/0032651 A1
(43) Pub. Date: Jan. 30, 2014

(54) SYSTEM AND METHOD FOR DELIVERING CLOUD BASED UTILITY SERVICES

(71) Applicant: NOVATIUM SOLUTIONS PVT. LTD., CHENNAI (IN)

(72) Inventors: Alok SINGH, CHENNAI (IN); Gopinath Vinod KUMAR, CHENNAI (IN); Gowrisankar RADHAKRISHNAN, CHENNAI (IN); Kasammuthu SURESH, VELACHERY (IN); Raj KUMAR, THE NILGRIS (IN); Ragunathan RAMALINGAN, OOTY (IN)

(73) Assignee: NOVATIUM SOLUTIONS PVT. LTD., CHENNAI (IN)

(21) Appl. No.: 13/954,939

(22) Filed: Jul. 30, 2013

(30) Foreign Application Priority Data
Jul. 30, 2012 (IN) 3114/CHE/2012

(51) Int. Cl. H04L 29/08

(52) U.S. Cl. CPC H04L 67/10
USPC 709/203; 709/204

(57) ABSTRACT

System and method for delivering cloud based utility services to a plurality of user devices associated with a user in a cloud based managed utility computing environment are provided. The system comprises a client side component having a client controller configured for receiving user profile, applications, content and type and characteristics of each of the user devices, a user interface for accessing the user profile, applications, content and type and characteristics of each of the user devices and a native interface for interacting with at least one operating system of each of the user devices. The system further comprises a server side component configured for acquiring the user profile, applications, content and type and characteristics of each of the user devices. The server side component is configured for delivering the cloud based utility services based on the type and characteristics of each of the user devices associated with the user.

### CROSS-REFERENCE TO RELATED APPLICATIONS

This application claimed priority to Indian Application Serial No. 3114/CHE/2012 filed Jul. 30, 2012, the contents of which are hereby incorporated by reference.

### FIELD OF INVENTION

The present invention relates to data communication systems and methods and more particularly to a system and method for delivering cloud based utility services to a plurality of user devices associated with a user.

### BACKGROUND OF THE INVENTION

Cloud computing represents a different way to architect and remotely manage computing resources. For example, cloud computing systems may include servers, network storage devices, and other information technology (IT) services. The cloud computing system encompasses resources (hardware, software, infrastructure and services) that can be accessed through the Internet. Cloud computing systems include interfaces to access their respective computing resources. These systems provide different applications or desktop as a service.

The utility cloud computing models allow the user to access the computing resources, platform services and application hosting as and when required in the cloud based server or locally in the user end devices. So the utility computing model offers a number of benefits to both service providers and users. The utility cloud computing models are more adaptive and competitive. Even though the current models of utility and cloud computing do some amount of management of resources on the backend the user device is not getting managed completely. They can only access the resource using a cloud based application, like a browser to access a web based solution.

Various systems and methods exist as means to deliver the cloud based resources and manage the profile of users available on the server side devices. One of the systems is accessing multiple applications by multiple client devices (e.g., client device) through the server device. The server device may include an application template to emulate a function of the application. In one or more embodiments, a provisioning module may provide application template for execution of each application of the client device. Depending on the need of the application, the provisioning module may choose one or more of the application templates to provide to the client device for execution of the application on a host operating system of the server device. The applications may however be installed on the server device when the user initially tries to install the applications in the client devices. On providing appropriate application templates, the applications may be executed on a virtual container of each of the client devices. The different virtual containers may include, for example, different components to support different operating system components (e.g., Windows components, Linux components). On execution, the various versions of the given application executed through different virtual containers may run on different host operating systems. However, this system is based on the concept of letting users access to the application from an independent cloud based environment. The device used to access is not of interest to the solution beyond the fact that it runs certain application(s) used to access the cloud. The applications are not managed or integrated with the cloud environment. Typically, in the existing utility and cloud computing solution, the management happens on the server side (beyond the cloud from the user's point of view) and the user is not worried about management responsibility of this environment. Moreover, the maximum that this solution provides is to have different versions of the client access application available for the devices operating on different platforms. Nonetheless, there is no tailoring of application to the characteristics of the devices.

Another system describes various embodiments that enables content such as applications, media files, user data, and other information to be synchronized between devices, where each device is able to receive at least some instances of that content in a format that is dynamically determined to be appropriate for the device, based on information such as various capabilities of that particular device. Various embodiments can also enable devices to interact even when the devices are of different types that might utilize different protocols, formats, or other options or capabilities that might otherwise not enable those devices to communicate or work together for at least some purposes. They do not integrate with the client end applications and capacities and hence cannot provide the user with a complete hassle-free experience. In general, the current solution only take care of providing a cloud based environment that can be accessed by any device but does not merge with the device itself and tailor the solution that is available to the user as per the device's characteristics.

Yet another system describes about managing a client desktop with respect to accessing cloud services. The system includes means for dynamically determining, viewing, organizing, and linking desktop objects to associated server side cloud resources and services. Specifically, the solution provides a mechanism whereby cloud services can be automatically represented on a plurality of client systems (for example, laptops, desktops, PDAs, etc) complete with the ability for the underlying provider of those services to be dynamically mapped based on a user's profile. The user will see standard available services regardless of the provider. However, there is no seamless flow of look and flow or tailoring of application to the device's capabilities. For example, if the user would like to access educational content from a server, the content is available to user in a certain format and screen resolution. It does not change as per the device characteristics. So if the user is using a media box it should be provided in HD format but in a mobile phone it should be provided in a lower resolution format. The current solutions available do not take care of these customizations.

A need therefore exists for a system and method for delivering cloud based utility services to a user, overcoming the drawbacks of the systems discussed above and also several other shortcomings inherent to the existing prior art.

### BRIEF DESCRIPTION OF THE INVENTION

The above-mentioned shortcomings, disadvantages and problems are addressed herein which will be understood by reading and understanding the following specification.

In one embodiment, a system for delivering cloud based utility services to a plurality of user devices associated with a user is provided. The system comprises a client side component comprising a client controller configured for receiving user profile, applications, contents and type and characteristics of each of the user devices. The client side component further comprises a user interface configured for accessing the user profile, applications, contents and type and characteristics of each of the user devices and a native interface configured for interacting with at least one operating system of each of the user devices. The system further comprises a server side component comprising a server interface configured for interfacing with each of the user devices associated with the user via a cloud based network, a usage manager configured for managing server data, the usage manager further configured for detecting and recording applications executing in each of the user devices and a profile manager configured for managing the user profile of the user. The server side component is configured for delivering the cloud based utility services based on the type and characteristics of each of the user devices associated with the user.

In another embodiment, a method for delivering a cloud based utility services to a plurality of user devices associated with a user in a cloud based managed utility computing environment is provided. The method comprises registering the user in the cloud based managed utility computing environment, acquiring type and characteristics of each of the devices associated with the user by a server side component and delivering the cloud based utility services to the user based on the type and characteristics of each of the user devices.

In yet another embodiment, a computer program product for delivering cloud based utility services to a plurality of user devices associated with a user in a cloud based managed utility computing environment is provided. The computer program product comprising a computer readable storage medium having computer readable program code embodied therewith, the computer readable program code comprising: computer readable program code configured to register the user at the cloud based managed utility computing environment, computer readable program code configured to acquire type and characteristics of each of the devices associated with the user by a server side component, and computer readable program code configured to deliver the cloud based utility services to the user based on type and characteristics of each of the user devices.

Systems and methods of varying scope are described herein. In addition to the aspects and advantages described in this summary, further aspects and advantages will become apparent by reference to the drawings and with reference to the detailed description that follows.

### BRIEF DESCRIPTION OF THE DRAWINGS

FIG. 1 shows an exemplary cloud based managed utility computing environment from which various components may be executed, as described in an embodiment; and

FIG. 2 shows a block diagram of a system for delivering cloud based utility services to a plurality of user devices associated with a user, as described in another embodiment.

### DETAILED DESCRIPTION OF THE INVENTION

In the following detailed description, reference is made to the accompanying drawings that form a part hereof, and in which is shown by way of illustration specific embodiments, which may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken in a limiting sense.

The present invention generally relates to data communication systems and methods and more particularly to a system and method for delivering cloud based utility services to a plurality of user devices associated with a user in a cloud based managed utility computing environment.

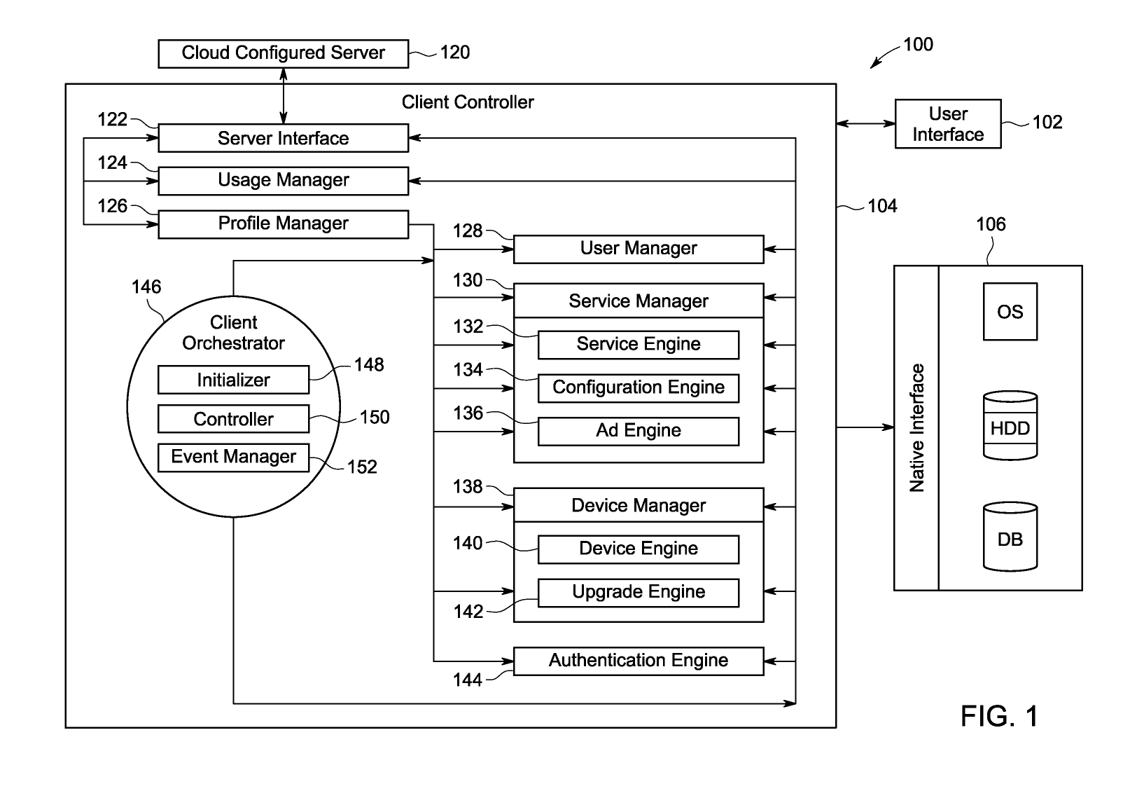

With reference to FIG. 1, shows an exemplary cloud based managed utility computing environment from which various components may be executed, in accordance with one embodiment of the present invention is provided. As shown in FIG. 1, the environment 100 comprises a client controller 102, user interface 104 and native interface 106. The client controller 102 is configured for receiving user profile, applications, content and type and characteristics of each of the user devices associated with a user. The user interface 104 is configured for accessing the user profile, applications, content and type and characteristics of each of the user devices and a native interface 106 is configured for interacting with at least one operating system of each of the user devices.

The environment 100 further comprises a service interface 110 configured for interfacing with each of the devices associated with the user via a cloud based network, a usage manager 112 configured for managing server data, the usage manager 112 further configured for detecting and recording applications executing in each of the user devices and a profile manager 114 configured for managing the user profile of the user.

The environment 100 further comprises a client orchestrator 134 communicatively coupled with the server interface 110, usage manager 112 and profile manager 114, the client orchestrator 134 configured for performing a coordinated sequence of request/response transactions between the cloud based managed utility computing environment and each of the user devices.

The client orchestrator 134 comprises an initializer 136 configured for initializing at least one cloud based utility service requested by a user in a cloud based managed utility computing environment, a controller 138 configured for controlling the cloud based utility services, and an event manager 140 configured for controlling and managing events that arise in the device in the cloud based managed utility computing environment and their resultant actions.

The profile manager 114 comprises a user manager 116 configured for communicating with the user devices via a network interface and identifying and providing information on requested and requsite applications for the user, a service manager 118 configured for managing the cloud based utility services within the cloud based managed utility computing environment, a device manager 126 configured for managing each of the user devices communicated with the cloud based managed utility computing environment and an authentication engine 132 configured for authenticating the user and each of the user devices based on the user profile and the type and characteristics of the user devices.

The service manager 118 comprises a service engine 120 configured for enabling access to service resources, a configuration engine 122 configured for synchronizing configuration information and configuration programs from the cloud based managed utility computing environment to each of the user devices, and an advertisement engine 124 configured for receiving the user profile and accessing types of advertisement based on the user profile.

The device manager 126 comprises a device engine 128 configured for determining the type and characteristics of each of the user devices and an upgrade engine 130 configured for communicatively coupling with the client controller 102 and further configured for receiving upgrade information of each of the user devices via the client controller 102.

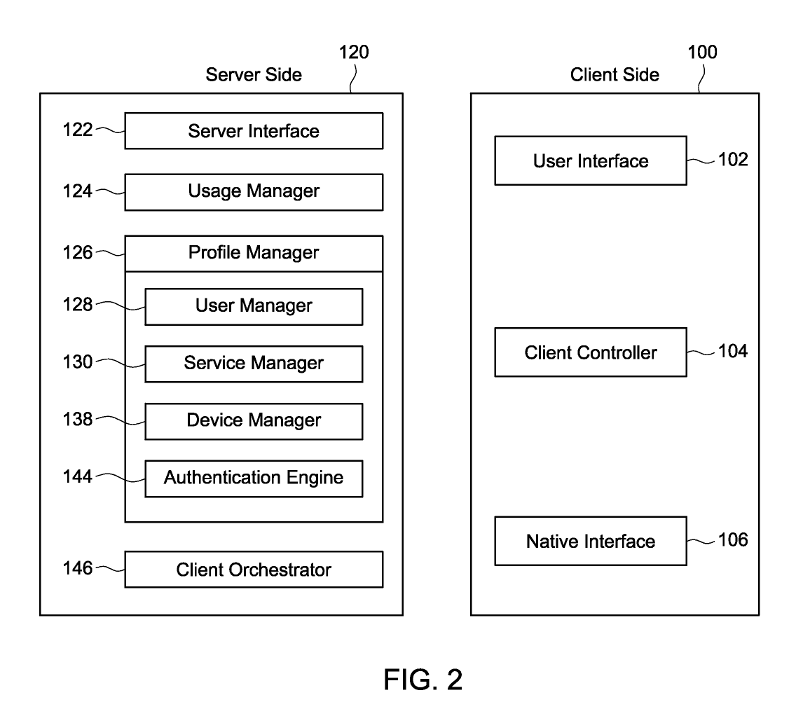

Turning now to FIG. 2, in another embodiment, the invention provides a cloud based managed utility computing environment. In this environment, the user's computing environment is controlled and managed by a set of applications. Accordingly, the invention describes a system 200 for delivering cloud based utility services. The system 200 comprises a client side component 202. The client side component 202 comprises a client controller 204, user interface 206 and native interface 208. The client controller 204 may control the different aspects of each of the user devices, the user interface 206, applications and content. The user may access the cloud based utility services via the user interface 206. The user interface 206 may be rendered in a web browser or could be on a native desktop interface.

The client controller 204 is configured to interact with the at least one operating system on each of the user devices to identify at least one application and content that are subscribed by the user and to keep track and control over the type and characteristics of each of the user devices.

The client controller 204 is further configured to manage upgrading of at least one operating system of each of the user devices. The client controller 204 may communicatively couple with the upgrade engine 130 and receive upgrade information of each of the user devices. Thus, the cloud based managed utility computing environment may automatically updated when each of the user's device automatically upgrades to new versions of operating system and applications.

In one embodiment, the native interface 208 may be an operating system interface that interact with the at least one operating system on each of the user device. Further, the user's environment may be managed and controlled by the native interface 208.

In one embodiment, the cloud based utility services may comprise cloud based resources, at least one application and content. The cloud based resources may comprise at least one of a set of user applications, an operating system, processor cycles, memory allocation, input/output (I/O) bandwidth, minimum uptime, instantiation schedule, subscription cost, network latency, and service level agreement.

The system 200 further comprises a server side component 210. The server side component 210 is communicatively coupled with the client side component 202 and maintained in a cloud based managed utility computing environment as shown in FIG. 1, The server side component 210 is configured for acquiring the user profile, applications and contents and device profile from the client controller 204. The device profile may comprise type and characteristics of the user device. The client side component 202 may comprise a plurality of user devices that are managed and monitored by the server side component 210 in a cloud computing environment. In one embodiment, each of the users may differ and each user may have one or more user devices. Further, each of the users may be provided with authentication details that may be used by the user while logging in the cloud based managed utility computing environment for accessing the cloud based utility services. Each of the users may be registered within the cloud based managed utility computing environment by entering the user profile and profile of one or more devices associated with the user. The user profile enables the server side component 210 to authenticate the user and to provide applications and content of user's interest. The authentication details may comprise a user identification data and password. Thus, the system 200 ensures the users a safe and secure environment on any user device based on these authentication data.

In one embodiment, the system 200 is configured to deliver the cloud based utility services to the user based on the type and characteristics of each of the user devices associated with the user. The type and characteristics of the user devices may comprise at least one of configuration, format, installation, screen resolution, operating systems, device identifier and usage pattern.

In one embodiment, the user profile and type and characteristics of each of the user device can be acquired by the server side component 210. The server side component 210 is automatically get updated when the user manipulates the information. Further, the server side component 210 supports various types of operating systems (OS) and user devices (from smart phones to computers).

In one embodiment, the user can move the authentication session from one user device to another user device while all the other relevant parameters are maintained. Only the applications and content specific to the user device may be changed. Thus, the server side component 210 may provide mobility across user device from smart phones to tablet to personal computer without discontinuing the session or changing the session characteristics.

In one embodiment, the user devices may comprise one of a smart phone, a cellular phone, a notebook, a tablet, a personal computer and a personal digital assistant. Each of the user devices may be configured for running different operating systems and further configured for having different characteristics. Each of the user devices are identified with a device identifier (device ID). The application and content provided are related to the type of each of the user devices. Thus, the application and content types may have an instance associated with the type of each user device. This determines the characteristics of the application and content for that particular user device, for example, encoding format, executable type, resolution of the content and the like. Further, the single instance of application and content may include multiple versions corresponding to the type and characteristics of each of the user devices.

In one embodiment, at least one application and content are accessed using different protocols including at least one of Hypertext Transfer Protocol (HTTP) for web based application, for web based application on mobile devices, Handheld Device Transfer Protocol (HDTP) for web based application, Real Time Streaming Protocol (RTSP) for streaming content; File Transfer Protocol (FTP) for applications and content; Real-time Transport Protocol (RTP) for streaming content; Real-Time Transport Control Protocol (RTCP) for streaming content; Bluetooth Phonebook Access (PBAP); and AT command-based information retrieval.

In one embodiment, the streaming content and the web based application may be available on a remote server that is running on at least one of cloud based virtual desktop environment, private terminal server and private virtual desktop environment. Further, the at least one application and content may be available from any of the cloud based environment without configuring the user devices.

In one embodiment, the streaming content and the web based application may be available on each of the user devices either by pre-burning the user devices or by installing the installable or application provided via a cloud based network when the user subscribes for the cloud based utility services.

A method for delivering a cloud based utility services to a plurality of user devices associated with a user in a cloud based managed utility computing environment in another embodiment of the present invention comprises steps of registering the user at the cloud based managed utility computing environment, acquiring type and characteristics of each of the user devices associated with the user and delivering the cloud based utility services to the user based on the type and characteristics of each of the user devices.

The method of registering the user comprises generating a user profile of the user, obtaining information on each of the user devices used by the registered user, and storing the user profile and the information in the cloud based managed utility computing environment. The user profile may be generated by inputting information on characteristics and interest of the user.

In one embodiment, the user subscribes to the cloud based service provider utilizing one more user devices storing at least a part of the user profile. The user profile may comprise characteristics and interests of the user. Characteristics are the details about the user that are captured from the user itself. For example, name, age, sex, area of residence, occupation, and the like. The characteristics of the user are collected during the registration of users to the cloud based managed utility computing environment. During the registration process, some of the user characteristics may be captured for example age, occupation, name, address and the like.

The interest of the users comprises the personal choice of application and content. The information on the interest of the user includes the kind of activities and the content that the user would like to do with user device. For example, creating documents/files or playing games. The user device of the present invention has the user interface 206 through which the user can receive a number of application icon, Internet based information and content on the desktop itself. Also, the user could track his/her mails or chats through widgets on the desktop. The cloud based managed utility computing environment acts as middleware to provide at least one application and content from different application, storage media, content providers hosted on the Internet and on the utility computing servers.

In one embodiment, the user profile may comprise information on the at least one application and content that the user has subscribed to. In one embodiment, the user profile may comprise information on each of the user devices that the user uses to access the cloud based utility services. This information may be captured by the cloud based service provider as soon as the user has confirmed for the cloud based utility services.

In one embodiment, the user could also change the profile by removing or adding other customizations and personalization from time to time. These data are updated to the user profile which is managed and controlled by the client controller 204.

In one embodiment, the user interests may include the details of user device usage pattern. This information is collected based on the application, website and content used by the user. Based on these interests and usage information, the server side component 210 may decide what sort of contents, applications and websites that should be available for the user.

When the user requests for the cloud based utility services, the server side component 210 may authenticate each of the user devices associated with the user during user login to the cloud based managed utility computing environment based on the user profile. Further, the user is provided with at least one application and content based on the authentication. The system 200 may be configured to automatically determine each of the user devices based on the type and characteristics of each of the user devices.

In one embodiment, the cloud based utility services may be delivered to each of the user devices via a storage media. The user devices are pre-burned with a cloud based operating system. Further, the existing operating system like Linux, Microsoft Windows and Android are modified to operate with a cloud based managed utility computing environment. This may be enabled by managing and controlling the operating systems from the elements in storage media. Thus the user may access the cloud based utility services on desired operating system. Simultaneously, a cloud based service provider may operate management and licensing issues and lock the user devices exclusively to the cloud based utility services in order to prevent the overwriting of the cloud based operating system by another user.

In one embodiment, the cloud based utility services are delivered to each of the user devices by installing the cloud based utility services in the user devices. The service may be invoked automatically when the user logs in the cloud based managed utility computing environment. Further, software for a cloud based desktop may be supplied by Telecom service providers as a part of a USB modem dongle. Thus, when the user inserts the dongle to the user device, a cloud based desktop is created in the user interface of the user device. This creation can either occur by installing the cloud desktop based software onto the user device or by directly invoking the cloud based desktop from the dongle without a post installation of the software onto the user device.

In one embodiment, the user subscribes to the cloud based service provider for the cloud based utility services and subsequently, the cloud based utility services is automatically downloaded, installed and configured on each of the user devices associated with the user. Further, when the service runs on the user device it provides most of the management features, including features like Internet Access Control and Safety.

In one embodiment, for example, the invention provides a computer-readable/useable medium that includes computer program code to enable a computer infrastructure to deliver cloud based utility services as discussed herein. To this extent, the computer-readable/useable medium includes program code that implements each of the various processes of the invention. It is understood that the terms computer-readable medium or computer-useable medium comprise one or more of any type of physical embodiment of the program code. In particular, the computer-readable/useable medium can comprise program code embodied on one or more portable storage articles of manufacture, on one or more data storage portions of a user device, such as memory and/or storage system, and/or as a data signal (e.g., a propagated signal) traveling over a network (e.g., during a wired/wireless electronic distribution of the program code).

Computer-readable storage media refer to any non-transitory storage medium and that may allow for instructions to be provided to a central processing unit (CPU) for execution. Such media can take many forms, including, but not limited to, non-volatile and volatile media such as optical or magnetic disks and dynamic memory, respectively. Common forms computer-readable media include, for example, a floppy disk, a flexible disk, a hard disk, magnetic tape, a magnetic disk, any other magnetic medium, a Compact Disk-Read Only Memory (CD-ROM) disk, Digital Video Disk (DVD), any other optical medium, Random Access Memory (RAM), Programmable Read-Only Memory (PROM), Erasable Programmable Read-Only Memory (EPROM), Electrically Erasable Programmable Read-Only Memory (EEPROM), a FLASH EPROM, cache memory and any other memory chip or cartridge.

As used herein, it is understood that the terms “program code” is a code, or notation of a set of instructions intended to cause a user device having an information processing capability to perform a particular function either directly or after either or both of the following: (a) conversion to another language, code, or notation; and/or (b) reproduction in a different material form. To this extent, program code can be embodied as one or more of: an application/software program, component software/a library of functions, an operating system, a basic device system/driver for a particular user device, and the like.

Many of the advantages provided by the system and method for delivering cloud based utility services to a plurality of user devices associated with a user described in various embodiments are listed below.

The system allows the user to access the cloud based managed utility computing environment utilizing a completely managed user device or a secure and managed application running in a non-managed user device.

The system automatically determines and stores the type and characteristics of the user device in the cloud based managed utility computing environment and tailors the cloud based utility services to the user based on the type and characteristics of the user devices.

The system allows the user to move a session or run multiple sessions on the plurality of user devices and with tailoring the session to the user device's type and characteristics.

This written description uses examples to describe the subject matter herein, including the best mode, and also to enable any person skilled in the art to make and use the subject matter. The patentable scope of the subject matter is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for delivering cloud based utility services to a plurality of user devices associated with a user, the system comprising:
a client side component comprising:
a client controller configured for receiving user profile, applications, contents and type and characteristics of each of the user devices;
a user interface configured for accessing the user profile, applications, contents and type and characteristics of each of the user devices; and
a native interface configured for interacting with at least one operating system on each of the user devices;
a server side component comprising:
a server interface configured for interfacing with each of the user devices associated with the user via a cloud based network;
a usage manager configured for managing data on the server side component, the usage manager configured for detecting and recording applications executing in each of the user devices; and
a profile manager configured for managing the user profile of the user;
wherein the server side component is configured for delivering the cloud based utility services based on the type and characteristics of each of the user devices associated with the user.

2. The system of claim 1, wherein each of the user devices is configured to enable users to access the cloud based utility services via the user interface.

3. The system of claim 1, wherein each of the user devices is configured for running different operating systems and further configured for having different characteristics.

4. The system of claim 2, wherein the user interface is a web browser or in some case from a controlled native user interface of the user device's operating system.

5. The system of claim 1, wherein the cloud based utility services comprise cloud based resources, at least one application and content.

6. The system of claim 5, wherein the cloud based resources comprise at least one of a set of user applications, an operating system, processor cycles, a memory allocation, input/output (I/O) bandwidth, a minimum guarantee of uptime, an instantiation schedule, a subscription cost, a network latency, and a service level agreement.

7. The system of claim 5, wherein the at least one application and content are accessed using different protocols selected from the group comprising Hypertext Transfer Protocol (HTTP) for web based application; Wireless Access Protovol (WAP) for web based application on mobile devices; Handheld Device Transfer Protocol (HDTP) for web based application; Real Time Streaming Protocol (RTSP) for streaming content; File Transfer Protocol (FTP) for applications and content; Real-time Transport Protocol (RTP) for streaming content; Real-Time Transport Control Protocol (RTCP) for streaming content; Bluetooth Phonebook Access (PBAP); and AT command-based information retrieval.

8. The system of claim 7, wherein the streaming content and the web based application are available on a remote server that is running on at least one of cloud based virtual desktop environment, private terminal server and private virtual desktop environment.

9. The system of claim 1, wherein the server side component is configured for acquiring the user profile, applications, contents and type and characteristics of each of the user devices associated with the user.

10. The system of claim 1, the client side component further comprises a client orchestrator communicatively coupled with the server interface, usage manager and profile manager, the client orchestrator configured for performing a coordinated sequence of request/response transactions between the server side component and each of the user devices.

11. The system of claim 10, wherein the client orchestrator comprises an initializer, a controller and an event manager, the initializer configured for initializing at least one cloud based utility service requested by a user in the cloud based managed utility computing environment, the controller configured for controlling the cloud based utility services, and the event manager configured for controlling and managing events that arise in the device and their resultant actions that needs to be managed by the server side component.

12. The system of claim 1, wherein the user profile comprises information on characteristics and interest of the user.

13. The system of claim 1, wherein the user profile comprises information on at least one application and content the user has subscribed to.

14. The system of claim 1, wherein the user profile comprises information on each of the user devices the user uses to access the cloud based utility services.

15. The system of claim 1, wherein the type and characteristics of each of the user devices comprises at least one of a configuration, a format, an installation, screen resolution, an operating system, a device identifier and an usage pattern.

16. The system of claim 1, wherein the client controller is configured for interacting with the at least one operating system on each of the user devices to identify the at least one application and content that is subscribed by the user and further configured for keeping track and control over the type and characteristics of the at least one user device associated with the user.

17. The system of claim 16, wherein the client controller is further configured to manage upgrading of the at least one operating system and related applications and content of each of the user devices associated with the user.

18. The system of claim 1 wherein the profile manager comprises a user manager, the user manager configured for communicating with each of the user devices via a network interface and identifying requested application by the user.

19. The system of claim 18 wherein the profile manager further comprises a service manager, the service manager configured for managing the cloud based utility services on the device of the user.

20. The system of claim 18 wherein the profile manager further comprises a device manager, the device manager configured for managing each of the user devices communicated with the server side component.

21. The system of claim 18 wherein the profile manager further comprises an authentication engine, the authentication engine configured for authenticating the user and each of the user devices based on the user profile and the type and characteristics of each of the user devices.

22. The system of claim 1, wherein the service manager comprises a service engine, a configuration engine and an advertisement engine, the service engine configured for enabling access to service resources, the configuration engine configured for downloading configuration information and configuration programs from the server side component to each of the user devices and the advertisement engine configured for receiving the user profile and accessing types of advertisement based on the user profile.

23. The system of claim 1, wherein the device manager comprises a device engine and an upgrade engine, the device engine configured for determining the type and characteristics of each of the user devices and the upgrade engine configured for communicatively coupling with the client controller and receiving upgraded information of each of the user devices.

24. The system of claim 1, wherein the user devices comprises one of a smart phone, a cellular phone, a notebook, a tablet, a personal computer and a personal digital assistant.

25. A method for delivering a cloud based utility services to a plurality of user devices associated with a user in a cloud based managed utility computing environment, the method comprising:
registering the user at the cloud based managed utility computing environment;
acquiring type and characteristics of each of the user devices associated with the user by a server side component; and
delivering the cloud based utility services to the user based on the type and characteristics of each of the user devices.

26. The method of claim 25, wherein registering the user comprises:
generating a user profile of the user;
obtaining information on each of the user devices associated with the registered user; and
storing the user profile and the information in the cloud based managed utility computing environment.

27. The method of claim 26, wherein generating a user profile comprises:
inputting information on characteristics and interest of the user.

28. The method of claim 25, further comprising:
requesting the cloud based utility services by the user having the plurality of user devices that is configured for accessing the cloud based utility services utilizing the cloud based managed utility computing environment.

29. The method of claim 25, further comprising:
authenticating each of the user devices associated with the user during user login to the cloud based managed utility computing environment based on the user profile.

30. The method of claim 29, further comprising:
providing at least one application and content to the user based on the authentication.

31. The method of claim 25, further comprising:
automatically determining each of the user devices associated with the user by the server side component based on the type and characteristics of each of the user devices.

32. The method of claim 25, wherein delivering a cloud based utility services comprises:
delivering a cloud based utility services to the user devices via a storage media.

33. The method of claim 25, wherein delivering a cloud based utility services comprises:
delivering a cloud based utility services to the user devices via downloading and installing the cloud based utility services on the user devices.

34. A computer program product for delivering cloud based utility services to a plurality of user devices associated with a user in a cloud based managed utility computing environment, the computer program product comprising a computer readable storage medium having computer readable program code embodied therewith, the computer readable program code comprising:
computer readable program code configured to register the user at the cloud based managed utility computing environment;
computer readable program code configured to acquire type and characteristics of each of the user devices associated with the user by a server side component; and
computer readable program code configured to deliver the cloud based utility services to the user based on type and characteristics of each of the user devices.

35. The computer program product of claim 34, further comprising:
computer readable program code configured to generate a user profile of the user;
computer readable program code configured to obtain information on each of the user devices associated with the registered user; and
computer readable program code configured to store the user profile and the information in the cloud based managed utility computing environment.

36. The computer program product of claim 35, wherein the computer readable program code configured to generate the user profile of the user comprises: computer readable program code configured to input information on characteristics and interest of the user.

37. The computer program product of claim 34, further comprising computer readable program code configured to receive a request for cloud based utility services from the user having the plurality of user devices that is configured for accessing the cloud based utility services utilizing the cloud based managed utility computing environment.

38. The computer program product of claim 34, further comprising computer readable program code configured to authenticate each of the user devices associated with the user during user login to the cloud based managed utility computing environment based on the user profile.

39. The computer program product of claim 38, further comprising computer readable program code configured to provide at least one application and content to the user based on the authentication.

40. The computer program product of claim 34, further comprising computer readable program code configured to automatically determine each of the user devices associated with the user by the server side component based on the type and characteristics of each of the user devices.
